(19) United States
(12) Patent Application Publication
(10) Pub. No.: US 2022/0092483 A1
(43) Pub. Date: Mar. 24, 2022

(54) CUSTOMER EXPERIENCE GENERATOR WITH SHAREABLE PROFILE AND AUTOPAY

(71) Applicant: Wells Fargo Bank, N.A., San Francisco, CA (US)

(72) Inventors: John Andrew Chuprevich, Davidson, NC (US); Lina Granados, Charlotte, NC (US); Jonathan Austin Hartsell, Mooresville, NC (US); H. Brock Kolls, Alpharetta, GA (US); Teresa Lynn Rench, Mount Holly, NC (US); Brendon Hartman Treanor, Charlotte, NC (US); Christina Zikeli, Charlotte, NC (US)

(21) Appl. No.: 15/917,185

(22) Filed: Mar. 9, 2018

(51) Int. Cl. G06Q 10/02; G06Q 20/10; G06Q 30/02; G06F 17/30

(52) U.S. Cl. CPC G06Q 10/02; G06F 17/30702; G06Q 30/0201; G06Q 20/102

(57) ABSTRACT

A computer-implemented system and method are provided for modifying and utilizing a sharable customer profile of a customer stored in a processing platform memory. The method comprises, during a scheduling phase, repeatedly performing a series of operations until an accepted itinerary is indicated. The series of operations include: receiving a set of initial or modified itinerary events, creating or modifying an itinerary utilizing the set of itinerary events, the customer profile, and vendor information that includes vendor employee scheduling information, and sending the itinerary to the customer for acceptance or modification of the itinerary or itinerary events. Once the itinerary is complete with no more modifications, the itinerary is finalized. Reservations are made at respective event vendors of the itinerary events, and confirmations for the event reservations are sent to the customer.

### TECHNICAL FIELD

Described herein is a computer-based system that generates a positive customer experience for events of an itinerary and creates a profile that is shareable between the customer and one or more vendors who are product or service providers. The system may make use of autopayments and may utilize a micropayment platform.

### BACKGROUND

A customer of a vendor may have certain preferences, and it may be to the advantage of the vendor to know and remember those preferences in order to allow the customer to have a better experience when dealing with the vendor. Collecting and sharing relevant information about the customer can help achieve such a better experience, as can allowing the customer to interact with a planning system based on information obtained from various vendors associated with an itinerary.

### SUMMARY

Disclosed herein is a computer-implemented method for modifying and utilizing a sharable customer profile of a customer stored in a processing platform memory. The method comprises, during a scheduling phase, repeatedly performing a series of operations until an accepted itinerary is indicated. The series of operations include: receiving a set of initial or modified itinerary events, creating or modifying an itinerary utilizing the set of itinerary events, the customer profile, and vendor information that includes vendor employee scheduling information, and sending the itinerary to the customer for acceptance or modification of the itinerary or itinerary events. Once the itinerary is complete with no more modifications, the itinerary is finalized. Reservations are made at respective event vendors of the itinerary events, and confirmations for the event reservations are sent to the customer.

Disclosed herein is also a customer experience generation system comprising a hardware processor, a non-volatile memory-based storage device connected to the hardware processor comprising instructions that, when executed on the processor, configure the processor to perform the following. During a scheduling phase, operations are executed repeatedly, until an accepted itinerary is indicated. The operations are to receive a set of initial or modified itinerary events, create or modify an itinerary utilizing the set of itinerary events, the customer profile, and vendor information that includes vendor employee scheduling information, and send the itinerary to the customer for acceptance or modification of the itinerary or itinerary events. Once the itinerary is complete with no more modifications, the itinerary is finalized. Reservations are made at respective event vendors of the itinerary events, and confirmations for the event reservations are sent to the customer.

Described herein is also a non-transitory computer-readable storage medium, the computer-readable storage medium including instructions that when executed by a processor, cause the processor to perform the operations described above.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1 is a block diagram providing an overview of an example customer experience generator system, according to an implementation.

FIG. 2 is a flowchart illustrating an example process of the system interacting with a customer to create an itinerary for the customer during a scheduling phase, according to an implementation.

FIG. 3 is a flowchart illustrating an example process 300 of the system 100 interacting with a customer during an execution phase of the itinerary created for the customer, according to an implementation.

FIG. 4 is a block diagram illustrating an example of a machine that may be a computer on which various processes described herein may be performed.

FIG. 5 is a block diagram of an example of a distributed computing system within which various processes described herein may be performed.

### DETAILED DESCRIPTION

Described below is a system that allows a customer to create an itinerary made up of one or more events (the events may each be broken down into sub-events or stages of an event) based on a customer profile that may include customer-indicated preferences and past experience data of the customer, and to execute the itinerary. The events may be associated with a vendor (merchant) who is a product or service provider, and, based on client-provided permissions, may allow a sharing of some or all of the customer profile data among vendors.

A customer-modifiable itinerary may be created that allows the customer to maximize a positive experience for the itinerary and its constituent events, and customer/vendor interactions with the system minimize efforts needed to enjoy the events. A “know me” experience may thus be created by allowing information associated with the customer to track to businesses that the customer is or may be involved with. The information presented to a business may be customer-provided information, information collected from that business, and/or information collected from other businesses or social media. When a customer enters a venue associated with a particular event, she may experience “very important person (VIP)” treatment, that is, a treatment that vendors afford to well-known good clients. Knowing the customer's detailed preferences can help drive the service provided to the customer—the more the vendor knows the customer, the more positive of an experience may be provided to the customer.

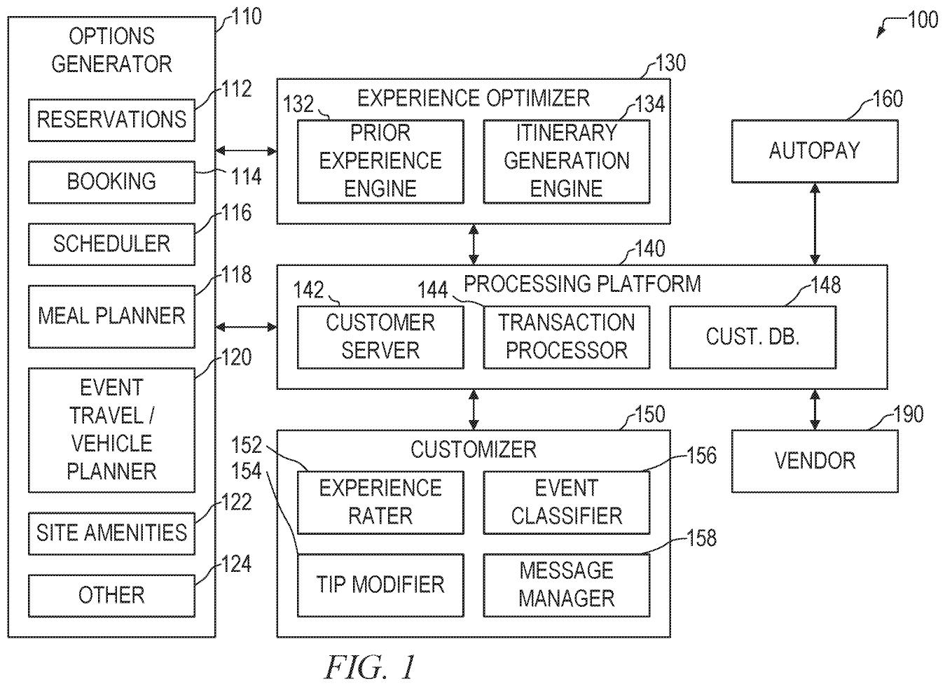

FIG. 1 is a block diagram providing an overview of a customer experience generator system 100 that may be utilized to provide an optimized customer experience for planning one or more activities. The system 100 may be used to optimize and improve a customer experience at a variety of events and hospitality service providers. The customer experience may be improved in a number of ways, including the customer being automatically recognized at an event venue, the customer automatically receiving customized preferences and treatment, automated handling of routine operations, such as payment, the ability for the customer to provide feedback using, for example, micropayments, and by sharing customer information (as permitted by the customer) among merchants that may include information created by the merchants.

The system 100 may assist the customer/user in creating a comprehensive itinerary, with each component or event of the itinerary incorporating customer profile information along with vendor information associated with various events of the itinerary. The customer profile information may be obtained from a variety of sources, including use of tools such as customer surveys (manual or on-line) and customer feedback information. Typical events that may be associated with, for example, a business trip itinerary may include travel (flight/airline and transportation to/from airports and various other events in the itinerary), hotel/lodging, dining, and entertainment.

The customer profile may contain information related to each of the events in an itinerary, and may include generalized information as well as vendor-specific information. For example, general information such as food and drink preferences (vegetarian, domestic wines only) and food allergies (allergic to shellfish), table, or server may be included within the customer profile, but the profile may be continuously updated based on feedback provided by the customer. Vendor-specific information may also be included in the customer profile as well, such as particular menu items or server/staff the customer is fond of. The customer feedback may be used to produce a more satisfying future experience. In this regard, customer feedback may be related to the events described above, including lodging or hospitality experiences involving restaurant visits, lodging stays (hotel chain, bed and breakfast, hostel, breakfast options, location, shuttle availability, etc.), air travel/flight (airline name, seating preference, preferred times, food amenities, etc.), ground transportation services (service name, driver, car type, rental car agency, etc.), and other service-related experiences.

The system 100 may be broken down into various components, such as an options generator 110, an experience optimizer 130, a processing platform 140, and a customizer 150, each described in more detail below.

The options generator 110 presents a number of planning options that a customer may use to create an itinerary in conjunction with the processing platform 140 that utilizes a customer server 142 to perform processing of customer-related activities associated with the processing platform 140. The processing platform 140 may serve as a centralized component for interacting with the other elements and maintain databases 148 accessible by the customers and vendors 190 alike. The options generator 110 may be implemented as an app on a smartphone of the customer or a client application running on a customer computer. The operations and functions described herein may run in software elements provided on customer devices and on server or cloud-based devices-functionality may be split across network components.

The customer experience may utilize the options generator 110 to access various planning activities for desired events. The options generator 110, including its respective components, may interact with the processing platform 140 to develop an option itinerary for the customer to review. In order to plan reservations for an event, the customer may utilize a reservation component 112, which may be initiated by a customer using their mobile device to indicate which types of reservations they are interested in making. Common choices may include making reservations for restaurants, entertainment, travel, lodging, or other types of events. In an example, a customer who lives in Chicago may decide she needs to make plans for an upcoming two-day business trip to Seattle, where she has been a number of times in the past. Thus, she may select travel, lodging, and restaurants for the Seattle trip. The reservations component 112 may need to be provided with certain broad scheduling features of the trip, such as the required dates for the business meeting, locations, and other particulars relevant to options that may be provided.

A booking component 114 may be provided that deals with information related to customer history and preferences as well as available vendor attributes. For example, the booking component 114 may determine which available vendor attributes, such as familiar or preferred tables at a restaurant or in other event spaces or which airline seats that are preferred by the customer, are available. Knowing whether the customer can get their favorite table, seat, or other preferences may make a difference in whether the customer chooses to attend the event. In the example above, the booking component 112 may suggest several restaurants in Seattle, some of which the customer has previously been at and indicated a positive experience, and possibly some new restaurants that the component identifies as similar to those the customer has historically enjoyed. It may also suggest different airline flights that the customer might take, knowing the customer's preferences for a particular airline, window seats, and red-eye flights.

A scheduler 116 may be provided that may utilize customer history and preferences from the experience optimizer 130 to determine availability of staff at each of the selected locations. For example, the customer may have a favorite waiter at their favorite restaurant in Seattle. The scheduler 116 may have access to the restaurant's staff scheduled for a particular evening to determine how to prioritize that restaurant to the customer. If the customer has favorite servers at different restaurants, the options scheduling component could offer several options, depending on availability, possibly ranking them according to past preferences of the customer.

In one implementation, and the scheduler's 116 access to the restaurant's schedule is passive, and the customer may decide whether or not to eat at a particular restaurant depending on the presence or absence of a particular server (or possibly reschedule the dinner to a night when that server would be available. However, it is also possible that in certain instances, the scheduler 116 could actively request that certain servers work during a period of time on a particular evening at a restaurant. If the customer were a big enough spender, or perhaps by paying a service charge or guaranteeing a minimum bill, (or based on some other criteria) a single customer request could be sufficient to rearrange a restaurant's staffing schedule for the evening. In another implementation, a plurality of customer requests could be collected and analyzed, e.g., using a weighted factor (or weighted customer) analysis-if enough of the right kind of customers expressed an interest in a particular server, that might be adequate for rearranging the restaurant's staffing schedule.

As an example, the customer wishes to make a reservation at Andaluca, but the scheduling component, looking at the server schedule, notes that the customer's favorite server will not be available on the desired evening. The customer, using the scheduling component, puts in a request for their favorite server. Hearing nothing back immediately, the customer makes reservations elsewhere. Three hours later, enough people have requested the customer's favorite server, and Andaluca contacts this server to see if he would be available for the evening (perhaps offering some monetary or other incentive to do so, which may be based on a customer service charge or guaranteed customer bill, as noted above). The server indicates he would be. Andaluca sends this information to the processing platform 140, which interfaces with the scheduler 116 and notifies the customer of the newly established availability of her favorite server at Andaluca. The customer, seeing this, decides to switch restaurant reservations to Andaluca.

A meal planner 118 may allow the processing platform 140, for restaurant-related activities and using customer history and preferences, to interact with the customer to select meals, wines, and other dining options as appropriate for the event. In the above use case, the customer likes to have a shrimp cocktail and a glass of Prosecco waiting for her when she arrives. This may be communicated via the meal planner 118 to the restaurant. Upon detection of the customer arriving at the restaurant, a notification may be sent to the kitchen to begin preparing the shrimp cocktail and a martini. Certain other events, such as a concert or hockey game, may or may not have food options.

If the meal planner 118 has access to enough customer preferences far enough in advance, this could impact the vendor's activities on certain days. For example, if enough customers who like brussel sprouts are scheduled to dine with the vendor 190 on a particular day, and this is known a week in advance by the vendor 190, then the vendor 190 may purchase extra brussel sprouts for that particular day. Thus, business decisions could be made based on such customer profile information.

An event travel/vehicle planner 120 may arrange travel as appropriate to, from, and in between the events. In an example implementation, the customer may have a preferred car service and driver. In the above example, the customer has a favorite Lyft driver that she uses when in Seattle. This component may obtain information about the flight arrival time from the processing platform 140 and send it to the Lyft driver so that the driver can be at the airport in a timely manner to pick up the customer and take her to her hotel. As such, availability of the services and driver may be arranged in advance, but may also be updated to accommodate schedule changes, such as a flight delay. In another example implementation, air travel with customer preferred airline, routes, departure time, seating preference, loyalty program, ground service at destination, and other preferences can be checked for availability and scheduled.

A site amenities component 122 may be utilized for activities at or related to a visit location. For example, using customer history and preferences, this component can arrange, as appropriate, favorite activities, spa visits with favorite attending staff, etc. An other options component 124 may be utilized to perform other specific coordinating tasks that can be created and effectuated by way of the processing platform 140.

In one implementation, the customer may be relieved of having to deal with payment at the end of a particular event by an autopay component 160. The customer device may have a location sensor, such as a GPS component, and be able to determine when the customer is at a location where payment is needed. For example, if the customer is at the service desk, exit location, or parking lot of her hotel and it is on the indicated checkout day, the autopay component may determine that the customer is checking out and be able to interact with the hotel billing system, directly or indirectly via the processing platform 140. The autopay component 160 could operate in a similar manner for rental car return.

The experience optimizer 130 may interface with the options generator and the processing platform 140, and may comprise a prior experience engine 132 and an itinerary generation engine 134. The prior experience engine 132 may receive recommendations from the various components of the options generator 110. It may accumulate information based on the customer's past experiences with particular entities from a variety of sources. For example, may obtain reviews, positive ratings, and negative ratings provided by the customer to social media or web pages via a network interface, it may solicit direct input from the customer, it may make inferences based on a tip amount, amount of time spent at the location, etc. Artificial intelligence (AI) techniques may be utilized so that the prior experience engine can learn the customer preferences in different contexts and make various inferences. An inference engine may be able to determine, based on statistical analysis, that if a customer likes A & B, that they are also highly likely to like C as well—thus C may be offered when A & B are not available or as an alternative to A & B. Once these factors have been taken into account, a list of choices which best fits the timing and desires of the customer may be generated and passed to the itinerary generation engine 134.

The itinerary generation engine 134 organizes the options into an itinerary that may include maps, travel times between events, and other details, making a complete itinerary for the travel event that may be presented to the customer on their computing device. In one implementation, the customer may interact with the created itinerary via a user interface of their computing device to make changes and recommendations. Such recommendations may include changing the restaurant if the customer's favorite waitress is not available at the original restaurant or the favorite menu item is not available, for example. Other options may include selecting house or hotel pickup and return for the restaurant, specifying a number of people in a dinner party, a preferred time, table, staff, and food/beverage. Options may also include selecting late checkout from the hotel and breakfast room, or transportation to the airport.

Once modifications to an initial itinerary are made, processing then may return to the prior experience engine 132 where an updated set of prioritized options may be determined and passed to the itinerary generation engine 134. The itinerary generation engine 134 may then produce an updated itinerary with relevant updates based on the customer change request—this may possibly result in a completely revised itinerary. The updated itinerary may again be presented to the customer where the customer can interact with it and make any further changes. This process may continue until the customer is satisfied with the itinerary.

An example itinerary may be described as follows. It may include care service to a restaurant with a time for the pickup and an indication that the car service is for a hotel pickup (and address). It may include a dinner location/restaurant with a number of people in the party, a time, a table identifier, available staff, approximate cost of the meal, and amount of tip. The dinner portion could include a meal preference, wine preference, or other preferences for the dining experience. It may include car service to the hotel with a time for the pickup and an indication that the car service is for restaurant pickup with an address of the restaurant. It may include a hotel with room number and room preferences, and options such as late checkout and breakfast room service. It may include car service to the airport with a time for the pickup, and an indication that the car service is for a hotel pickup with the address. Thus, the itinerary may not only show the events, timing, and transportation but also may include a level of detail of meal, wine, room service, tip amounts (e.g., dollar amount of % of bill formula), and other details.

When the customer is satisfied with a particular itinerary, the customer may indicate that this itinerary is to be booked by interacting with a display element, such as a “Book” button on her device. Any deposit amount, ticket purchases, prepaid amount, or other costs may be effectuated by the processing platform 140 and the transaction processed by a transaction processor 144 that may be used to interact with systems of various vendors 190 to make necessary reservations.

The autopay component 160 may track the location of the customer's mobile device and use location information to perform other functions. For example, the customer's location may be detected when she leaves the restaurant, and this may prompt the processing platform 140 to initiate payment for the experience. If the customer has been to this restaurant before, then absent any indication of a bad experience, the autopay component 160 may calculate a same percentage tip as was left previously (or an average of historical tips). The event, tip, or partial tip payment(s) may be processed in the form of a micropayment across the transaction processor 144 via a network. An itinerary with many events, such as a restaurant, ground transportation, and hotel, may have each event or sub-event (segment) covered by a micropayment as they occur, the customer's location being tracked and determined by a location sensor, such as a GPS of the customer/customer's mobile device, or according to some other mechanism for location tracking.

Location tracking may be utilized for other purposes as well. For example, the customer's location may be utilized for scheduling purposes that might enhance the customer's experience. By way of example, a customer may schedule a reservation at a restaurant and indicate that she would like a martini for a drink and shrimp cocktail for an appetizer. If these items take ten minutes to prepare and get to the table, then GPS feedback of the customer's location, coupled with a third-party map and traffic service, could provide the restaurant notice when the customer appears to be within ten minutes of the restaurant to begin preparation of the drink and appetizer so that it can be waiting on the table when the customer arrives.

In one implementation, the precise location of the customer can be provided to further enhance the customer experience. As noted above, detecting the customer location near the exit after spending some time at the restaurant could be used as a trigger for autopayment of the meal. Additionally, noting that the customer has headed to the restroom may also alert the staff that dirty dishes may be cleared from the table and a new napkin provided. Noting that the customer is returning to the table from the restroom may alert the staff to have someone available to help seat the customer.

The location information may be utilized in connection with authentication information as well, so that a vendor may positively know the identity of the customer, e.g., upon arrival to the event venue. For example, when a customer enters a bank to conduct banking business, the customer may be identified through one or more authenticating procedures. One authenticating procedure may involve use of a wearable identification element or unique user device, such as a smartphone. Facial recognition or other forms of biometric identifiers may be utilized to help further authenticate the customer. The business may then access authenticated information about the customer either from its own database or a network/cloud-based customer database 148.

The customizer 150 may include an experience rater 152, a tip modifier 154, an event classifier 156, and a message to a message manager component 158. In an example implementation, the experience rater 152 allows the customer to easily provide via e.g., their mobile digital device, to rate the hospitality experience and, in an implementation to rate any portion of it. For example, the dining experience could be broken down into the following experience segments: drinks, appetizers, entre, desert. Ratings could be applied to each segment. The rating(s) may also be tied to the tip calculation. In addition to or as an alternative to segmenting the experience, the experience or segments may be rated on a plurality of categories, such as service and quality. The rated components (segments and categories) or an overall rating may be reported to a rating website, such as Yelp, and may be provided to the business at which the experience is taking place so that the business can improve their service.

An event classifier 156 may provide a way for the customer to classify the event according to various categories. For example, the hospitality event or portions of the event may be classified as being business or personal. The event classifier 156 may also assist in producing reports for the customer to assist with, for example, business travel reimbursement reporting or for tax purposes.

A tip modifier 154 may allow the customer to easily modify a tip amount or provide tip-related information based on the service or any other criteria. The tip modifier may permit a tip to be modified before, during, and after the event. This allows the customer to increase the tip after they leave the event or provide a tip to the proper person when the person cannot be subsequently located. Such a situation may occur, for example, if a pool side server takes care of the customer, but the server's shift ends and they leave before they can be tipped by the customer.

In one implementation, a particular tip may be designated prior to the experience, and then it may be modified during the course of the event, depending on the service. For example, a customer may designate a 20% tip prior to dining at the restaurant. However, if the customer is kept waiting for excessive amounts of time in between courses or is not offered a drink refill, the customer may begin deducting (or adding) percentage points based on various occurrences while they are participating in the event.

The message manager 158 may allow the customer to text, email, or otherwise communicate with the hospitality location before, during, and after the event. In an example implementation, the service staff at a restaurant could check in with the customer prior to arrival on event details, even if this is the first time the customer has been to that location, to determine customer preferences or early orders. In addition, the customer may message the management at any time as necessary.

Thus, if a customer goes to a restaurant and has an enjoyable experience, e.g., thinks the waitress is very good, and likes the meal selection, seating, etc., associated attributes (restaurant, menu, staff, meal price, tip amount, and other attributes) may become part of the preferences for this customer in stored in a customer database 148 in the processing platform 140. Thus, at a later time, if the customer desires a restaurant meal, the processing platform 140 may recommend the previously enjoyed restaurant, if selected as a part of the itinerary for this later time, coordinate the same table and service staff, if available, in order to optimize the customer experience and based on the stored customer data.

The customer profile stored in the database 148 may contain very detailed information about the customers. For example, a vendor may

This type of experience may be extendable to hotels, air travel, ground transportation, and any other venue or event that the customer would like to attend. Customer experience in these areas may contribute to the creation and maintenance of a robust customer profile so that when the customer wishes to create an itinerary, such an itinerary may be created with a minimum amount of effort on the device of the user in order to maximize the customer experience.

In one implementation, portions of customer profiles associated with one business may be shared with another business, provided the user grants permission to do so. Thus, the customer database 148 may contain information on a number of customers and this information may be available to a large number of vendors 190. Although normally a place of business might prefer to keep its knowledge of a customer to itself (or at least not share the information with a competitor), it may be willing to share information if it receives valuable information in return, according to some specified criteria. Alternately, businesses in business groups may have incentive to share information. For example, one restaurant of a restaurant chain in one city may be willing to share information with another restaurant of the same restaurant chain in another city in order to maximize goodwill with respect to the restaurant chain as a whole. Similarly, businesses may be willing to share customer profile information with other non-affiliated business that are not perceived as competitors. Thus, if a customer prefers sparkling water instead of tap water or has shellfish allergies, this information may be included in a shareable customer profile so that even if the customer plans to go to a restaurant for the first time, the restaurant may still know a great amount about the customer and things that it may do to make the customer's experience better.

The shareable customer data may be aggregated and utilized by the vendors 190, but information related to the vendors may be aggregated as well. For example, information about specific servers at a restaurant may be collected, and a server that consistently gets low customer ratings can be flagged as problematic so that the vendors 190 can deal with that particular server. Similarly, if a particular food item is consistently getting low customer ratings, the planning chef may decide to replace the food item with something else. Since servers can move around, it may be beneficial to track information about them using the system. Advantageously, the system may be able to empower a first-time server to have a considerable amount of knowledge of the customer, despite never having interacted with her.

In one implementation, the processing platform 140 may be able to access profile information in the customer database 148 of other customers who may be similar to the customer planning an itinerary in order to make recommendations. Other similarly situated customers (age, income, gender, ethnic background, etc.) may provide a good indication as to what the planning customer might find appealing and weight the recommendations accordingly. The processing platform 140 may use tip percentages left by the customer to rank the restaurants (in terms of a positive experience), since presumably one leaves a larger percent tip if they feel that their experience was a good one. The system may utilize loyalty points that may be transferred to a vendor 190 account to pay tips. This may allow the vendors 190 to accrue points. Such a model may enable large aggregations of points to be redeemed for more value rewards or perhaps credits on loans or types of business transactions provided by a financial institution associated with the customer. Such a financial institution may provide recommendations of other hospitality locations/vendors associated with the financial institution. This may, for example, be a business to consumer feature for business banking clients.

The system 100 may benefit the vendors 190 in helping them to understand whether providing the customer with various amenities makes sense from a business standpoint. For example, it may not be worthwhile for a vendor 190 to provide a gold-card experience for a customer who does not purchase a lot, leaves poor tips, or in some other way represents less profit for the vendor 190. In this case, the vendor 190 may still try to maximize the customer's experience, but within financial boundaries dictated by particular customer profile information stored in the customer database 148. Thus, the vendor 190 may also add information to the customer profile (business-collected information), and provide access control to the restricted access customer information to prevent customer access, that is, the customer from seeing information that may be helpful to the vendor 190, but may not be diplomatically sharable with the customer.

By way of example, a customer might be very picky and may easily get upset if anything at all goes wrong. However, if everything goes right, the customer may be a very good tipper. This information may be included by the vendor 190 in the customer profile, and may be shareable with other vendors, but not accessible by the customer herself. Also, the business-collected information that goes into the customer profile may include the best way to resolve problems if they arise. For example, if the customer's side orders came out late and the customer is upset, the business-collected information may include that the customer will not be satisfied with coupons for use on a future visit, but may be satisfied with a comped drink.

The customer information may be used collectively by the vendors 190. For example, if no one is ordering asparagus as a side, but many are ordering the brussel sprouts, then a restaurant could remove this item from its menu. If certain items are getting poor customer ratings or reviews, then these items may be replaced—this permits a vendor 190 to constantly improve their offerings.

Advantageously, use of this system 100 may empower a business or vendor 190 to know the customer and derive customer value and goodwill from customized, personal experiences, as well as to maximize key performance indicators (KPI) related to customers (more profits per customer, greater number of customers, business modeling (offers to customers)).

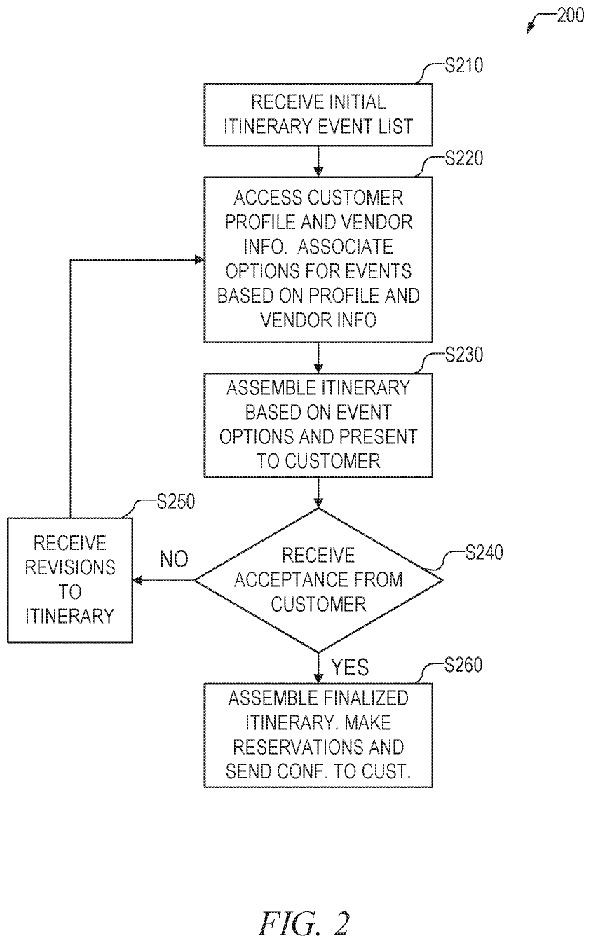

FIG. 2 is a flowchart illustrating an example process 200 of the system 100 interacting with a customer to create an itinerary for the customer during a scheduling phase, according to an implementation. In operation S210, the customer may provide an initial itinerary event list. The initial itinerary event list may be received by the processing platform 140. This event list may be a high-level event list that includes the basic components or events of an itinerary, such as an itinerary for a business trip, as described above. The itinerary may comprise, e.g., airfare, ground transportation, hotel, dining, and entertainment, and such components may be selected by the customer using user interface controls such as check boxes, radio buttons, and the like, from a plurality of itinerary events.

The initial itinerary event list may be just a shell, identifying the most basic components and serving as a placeholder for more detail. However, the customer may also provide specific preferences or constraints by, e.g., selecting from a list, typing in particulars, or entering in certain parameters for an event.

In operation S220, the processing platform 140 may obtain customer information from the customer profile stored in the customer database 148 as well as vendor information from the vendor 190. The availability of various vendors 190 or characteristics associated with a particular vendor 190 may be determined and based on: a) any specifics requested by the customer; b) customer preferences or positively rated items in the customer profile. The processing platform may utilize the prior experience engine 132 of the experience optimizer 130 to perform associations between events and specific options for events.

In operation S230, once the availability of the vendors 190 or characteristics of the vendors 190 has been determined, an initial itinerary that includes all of the events may be prepared by the itinerary generation engine 134 and presented to the customer. This initial itinerary may be presented to the customer in the form of an interactive app display or web page on a display device of the customer. The itinerary may list each event and relevant details for each event. The itinerary may be quite detailed showing sub-events for each of the events along with relevant details for some or all of the events as well. Sub-events may be further broken down into sub-sub-events, and so on, to form a hierarchical tree of any desired number of levels. As defined herein, the terms “event” and “sub-events” apply to any particular level event in such a hierarchical tree.

In operation S240, the customer may indicate which components of the itinerary are acceptable, for example, using a check box, an OK button, or other form of positive indication, and which events or sub-events are to be changed. The customer may either specify how the changes are to be done, or indicate that the processing platform 140 is to provide other options (possibly within additional constraints), and then, in operation S250, this information may be received by the processing platform 140. If revisions to the itinerary are indicated (S240:NO), then the process returns to repeat operation S220 with the new constraints or criteria. Once all of the elements of the itinerary have been accepted by the customer (S240:YES), then, in operation S260, the itinerary is finalized, event reservations may be made, and reservation confirmation(s) may be sent to the customer.

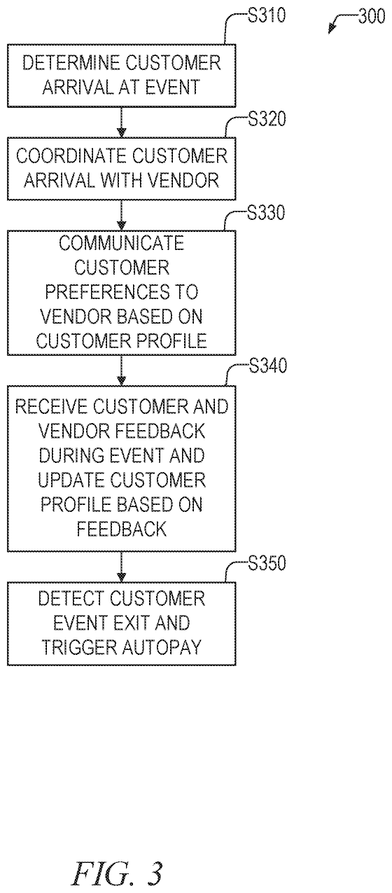

FIG. 3 is a flowchart illustrating an example process 300 of the system 100 interacting with a customer during an execution phase of the itinerary created for the customer in the process 200 of FIG. 2, according to an implementation. In operation S310, the processing platform 140 may determine the arrival of the customer at an event (or sub-event) of the itinerary, as described above. Any authentication procedures may be performed at this point in time as well.

In operation S320 (which may occur before, during or after operation S310), the processing platform 140 may coordinate the customer arrival with the vendor 190. As described above, this may involve scheduling various events to take place so that the customer may, upon arrival, begin to immediately enjoy the experience. In one implementation, actors of the vendor 190 (e.g., for a restaurant event, this may include wait staff, cooks, bus-persons, bartenders, and others) may be alerted to the actual customer arrival or planned arrival time via, e.g., smart phones so that each can begin activities associated with the event to maximize the customer experience. The planned arrival time may be determined by mapping services, such as Google Maps.

In operation S330 (which may occur before, during, or after operation S310-S320), the processing platform may access the customer database 148 to retrieve customer profile information relevant to the event and provide it to the vendor 190 so that the customer's experience is optimized. The customer profile in the customer database 148 may have previously received information from the prior experience engine 132 to incorporate positive and negative previous customer experiences that may be applied to the current event.

In operation S340, feedback, as received customer information, may be received by the processing platform 140 and the customizer 150. The customizer 150 may utilize the experience rater 152, tip modifier 154, event classifier 156, and message manager 158 as described above to. The customer profile in the customer database 148 may be updated with any changes related to the customer's experience of the current event. Additionally, the vendor 190 may also include feedback information relative to the customer that may also be incorporated into the customer profile. In this way, it may be possible to continuously update the customer profile with the customer's preferences.

In operation S350, at the conclusion of the event, the customer's exit from the event may be determined, and an autopayment, potentially adjusted by the tip modifier 154 or other element of the system 100, may be applied via the transaction processor 144. Any portion of the customer profile that has been modified or a modified customer profile may be utilized in creating a future itinerary.

### General Computer and Network Architecture

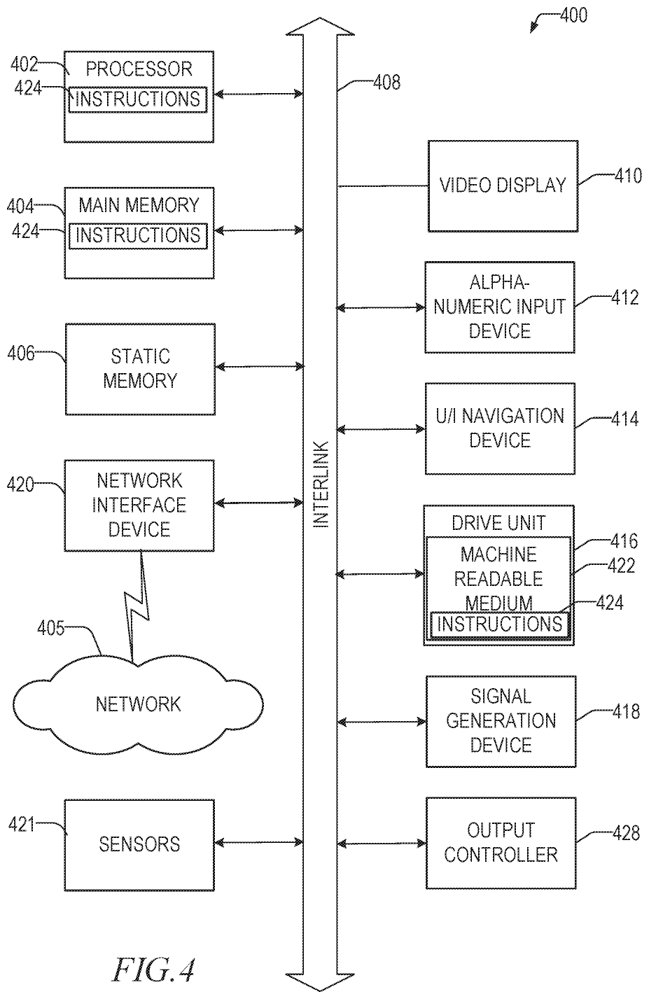

To describe some configurations in greater detail, reference is made to examples of hardware structures and interconnections usable in the designs of the present disclosure. FIG. 4 is a block diagram illustrating a machine 400 that may be a computer or computer system on which various processes described herein may be performed. The machine 400 or multiple such machines may form various parts or all of the system 100 described above. Such a machine 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example described herein, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB)), parallel, or other wired or wireless (e.g., infrared(IR), near field communication (NFC), etc.) controller connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over the communications network 405 using a transmission medium via the network interface device 420. The term “transmission medium” is defined herein to include any medium that is capable of storing, encoding, or carrying instructions for execution by the machine, and includes digital or analog communications signals or other medium to facilitate communication of such software.

The machine 400 may communicate with one or more other machines 400 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 402.11 family of standards known as Wi-Fi®, IEEE 402.16 family of standards known as WiMax®), IEEE 402.15.4 family of standards, a Long Term Evolution (LTE) family of standards, a Universal Mobile Telecommunications System (UMTS) family of standards, peer-to-peer (P2P) networks, virtual private networks (VPN), or any other way of transferring data between machines 400. In an example, the network interface device 420 may include one or more physical jacks (e.g., Ethernet, coaxial, or phone jacks) or one or more antennas to connect to the communications network 405.

In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

A wide variety of computing devices may constitute a machine 400, as described herein. The following list includes a variety of devices that may fit the definition of a machine 400: a personal data assistant (PDA), a cellular telephone, including a smartphone, a tablet computing device, a laptop computer, a desktop computer, a workstation, a server computer, a mainframe computer, and the like.

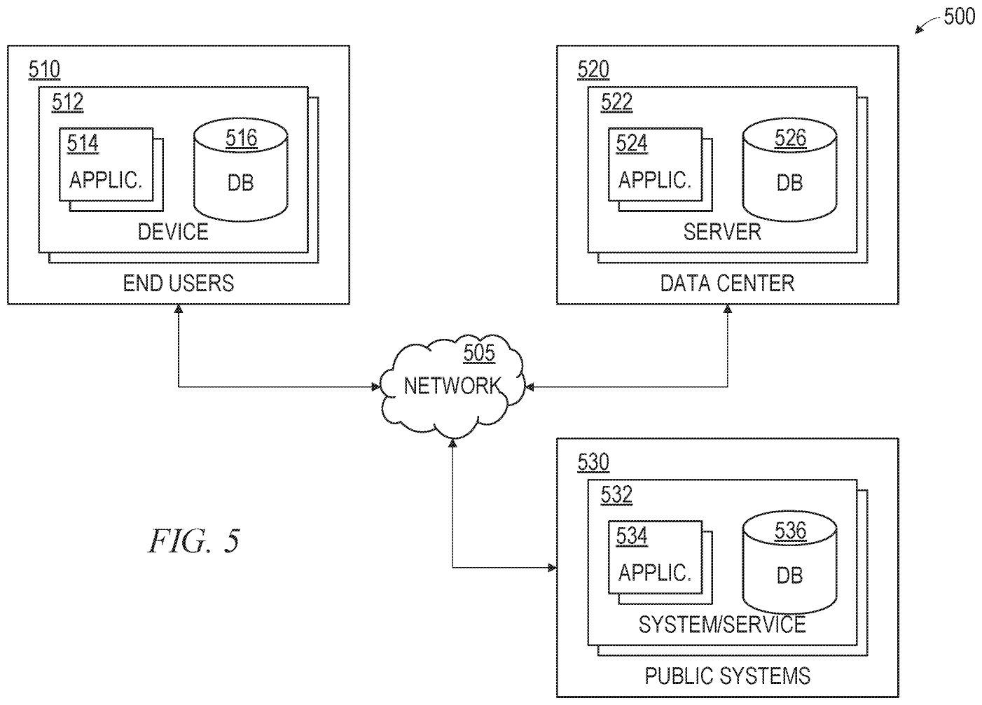

FIG. 5 is a block diagram of a distributed system 500 that may include a client-server architecture or cloud computing system. The system 500 may be a system 100 as described above. Distributed system 500 may have one or more end users 510. An end user 510 may have various computing devices 512, which may be machines 400 as described above. The end-user computing devices 512 may comprise applications 514 that are either designed to execute in a stand-alone manner, or interact with other applications 514 located on the device 512 or accessible via the network 405. These devices 512 may also comprise a data store 516 that holds data locally, the data being potentially accessible by the local applications 514 or by remote applications.

The system 500 may also include one or more data centers 520. A data center 520 may be a server 522 or the like associated with a business entity that an end user 510 may interact with. The business entity may be a computer service provider, as may be the case for a cloud services provider, or it may be a consumer product or service provider, such as a retailer. The data center 520 may comprise one or more applications 524 and databases 526 that are designed to interface with the applications 514 and databases 516 of end-user devices 512. Data centers 520 may represent facilities in different geographic locations where the servers 522 may be located. Each of the servers 522 may be in the form of a machine(s) 300.

The system 500 may also include publicly available systems 530 that comprise various systems or services 532, including applications 534 and their respective databases 536. Such applications 534 may include news and other information feeds, search engines, social media applications, and the like. The systems or services 532 may be provided as comprising a machine(s) 300.

The end-user devices 512, data center servers 522, and public systems or services 532 may be configured to connect with each other via the network 405, and access to the network by machines may be made via a common connection point or different connection points, e.g. a wireless connection point and a wired connection. Any combination of common or different connections points may be present, and any combination of wired and wireless connection points may be present as well. The network 405, end users 510, data centers 520, and public systems 530 may include network hardware such as routers, switches, load balancers and/or other network devices.

Other implementations of the system 500 are also possible. For example, devices other than the client devices 512 and servers 522 shown may be included in the system 500. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 522.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products.

Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like. The code may also be intangibly stored on one or more non-transitory and non-volatile computer readable media, such as those described above. In these cases, instructions resident on the media are read and executed by a processor to perform various functions.

The above description is intended to be illustrative, and not restrictive. For example, the above-described examples (or one or more aspects/configurations thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it should not be used to interpret or limit the scope or meaning of the claims.

Also, in the above Detailed Description, various features may be grouped together to streamline the disclosure. However, the claims cannot set forth every feature disclosed herein, as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the claims, along with the full scope of equivalents to which such claims are entitled.

1. A computer-implemented method for modifying and utilizing a sharable customer profile of a customer stored in a processing platform memory, the method comprising, using a processor:
during a scheduling phase:
repeatedly performing, until an accepted itinerary is indicated, the itinerary comprising at least two itinerary events:
receiving a set of initial or modified itinerary events;
creating or modifying, utilizing an artificial intelligence model trained to predict preferences of the customer, an itinerary utilizing the set of initial or modified itinerary events, the customer profile, social media posts of the customer describing reviews or ratings of one or more vendors, and vendor information that includes vendor employee scheduling information; and
sending the itinerary to the customer for acceptance or modification of the itinerary or itinerary events;
finalizing the itinerary;
making event reservations at respective event vendors of the itinerary events, the making of the event reservations including:
sending a request to a vendor of an event on the itinerary for scheduling a particular identified server for a period of time related to the event;
receiving information from the vendor about the scheduling of the particular identified server; and
sending the received information from the vendor to the customer;
sending confirmations for the event reservations to the customer; and
during an executing phase:
determining, based upon location data from a device of the customer that the customer is in, or is returning from, a bathroom of the itinerary event;
responsive to determining that the customer is in or is returning from the bathroom of the itinerary event, notifying the vendor of the itinerary event;
determining, based upon the location data from the device of the customer that the customer has spent a threshold amount of time at a location of an itinerary event;
after determining the customer has spent a threshold amount of time at the location of the itinerary event, determining, based upon the location data, that the customer has exited the location of the itinerary event; and
responsive to determining that the customer has exited the itinerary event, automatically paying a vendor corresponding to the itinerary event on behalf of the customer.

2. The method of claim 1, further comprising:
during the execution phase,
receiving customer information while the customer is attending an event of the itinerary;
modifying the customer profile based on the received customer information; and
utilizing the modified customer profile in creating a future itinerary.

3. (canceled)

4. The method of claim 2, further comprising receiving tip-related information during the event that modifies a payment amount to the vendor for the event.

5. (canceled)

6. The method of claim 2, further comprising:
determining a customer approach to the itinerary event; and
communicating the customer approach to the vendor that includes an arrival time.

7. The method of claim 6, further comprising:
scheduling activities with the vendor based on the customer profile or event reservation based on the arrival time.

8. The method of claim 2, further comprising performing an authentication of the customer.

9. The method of claim 2, further comprising:
receiving a plurality of ratings for a respective plurality of sub-events of the event; and
storing the plurality of ratings in the customer profile.

10. The method of claim 1, wherein the accepted itinerary is determined by each of the itinerary events having been customer accepted.

11. The method of claim 1, further comprising providing access to parts of the customer profile received from a first vendor to a second vendor.

12. The method of claim 1, wherein the customer profile further includes preferences for food, drink, food allergies, ground transportation, lodging, or flight.

13. The method of claim 1, further comprising:
utilizing a booking component to determine availability of available vendor attributes; and
presenting to the customer the available vendor attributes as a part of the itinerary.

14. The method of claim 13, wherein the available vendor attributes comprise the availability of:
for a restaurant:
food, beverage, table or server;
for ground transportation:
transportation service, driver, car type, or rental car agency;
for lodging:
hotel name or chain, bed and breakfast, breakfast options, location, or shuttle availability; and
for flight:
airline name, seating preference, preferred times, or food amenities.

15. (canceled)

16. The method of claim 1, further comprising utilizing customer ratings from the customer profile in the creating or modifying of the itinerary.

17. The method of claim 1, further comprising:
receiving vendor supplied information about the customer; and
storing the vendor supplied information about the customer in the customer profile with restricted access that prevents customer access of the vendor supplied information.

18. A customer experience generation system comprising:
a hardware processor;
a non-volatile memory-based storage device connected to the hardware processor comprising instructions that, when executed on the hardware processor, configure the hardware processor to:
during a scheduling phase:
repeatedly, until an accepted itinerary is indicated, the itinerary comprising at least two itinerary events:
receive a set of initial or modified itinerary events;
create or modify, utilizing an artificial intelligence model trained to predict preferences of the customer, an itinerary utilizing the set of initial or modified itinerary events, a customer profile of a customer, social media posts of the customer describing reviews or ratings of one or more vendors, and vendor information that includes vendor employee scheduling information; and
send the itinerary to the customer for acceptance or modification of the itinerary or itinerary events;
finalize the itinerary;
make event reservations at respective event vendors of the itinerary events, the making of the event reservations including:
sending a request to a vendor of an event on the itinerary for scheduling a particular identified server for a period of time related to the event;
receiving information from the vendor about the scheduling of the particular identified server; and
sending the received information from the vendor to the customer;
send confirmations for the event reservations to the customer; and
during an executing phase:
determine, based upon location data from a device of the customer that the customer is in, or is returning from, a bathroom of the itinerary event;
responsive to a determination that the customer is in or is returning from the bathroom of the itinerary event, notify the vendor of the itinerary event;
determine, based upon the location data from the device of the customer that the customer has spent a threshold amount of time at a location of an itinerary event;
after a determination that the customer has spent a threshold amount of time at the location of the itinerary event, determine, based upon the location data, that the customer has exited the location of the itinerary event; and
responsive to a determination that the customer has exited the itinerary event, automatically pay a vendor corresponding to the itinerary event on behalf of the customer.

19. The system of claim 18, wherein the instructions further configure the processor to:
during an execution phase,
receive customer information while the customer is attending an event of the itinerary;
modify the customer profile based on the received customer information; and
utilize the modified customer profile in creating a future itinerary.

20. A non-transitory computer-readable storage medium, the computer-readable storage medium including instructions that when executed by a processor, cause the processor to:
during a scheduling phase:
repeatedly, until an accepted itinerary is indicated, the itinerary comprising at least two itinerary events:
receive a set of initial or modified itinerary events;
create or modify, utilizing an artificial intelligence model trained to predict preferences of the customer, an itinerary utilizing the set of initial or modified itinerary events, a customer profile of a customer, social media posts of the customer describing reviews or ratings of one or more vendors, and vendor information that includes vendor employee scheduling information; and
send the itinerary to the customer for acceptance or modification of the itinerary or itinerary events;
finalize the itinerary;
make event reservations at respective event vendors of the itinerary events, the making of the event reservations including:
sending a request to a vendor of an event on the itinerary for scheduling a particular identified server for a period of time related to the event;
receiving information from the vendor about the scheduling of the particular identified server; and
sending the received information from the vendor to the customer;
send confirmations for the event reservations to the customer; and
during an executing phase:
determine, based upon location data from a device of the customer that the customer is in, or is returning from, a bathroom of the itinerary event;
responsive to determining that the customer is in or is returning from the bathroom of the itinerary event, notifying the vendor of the itinerary event;
determining, based upon the location data from the device of the customer that the customer has spent a threshold amount of time at a location of an itinerary event;
after a determination that the customer has spent a threshold amount of time at the location of the itinerary event, determine, based upon the location data, that the customer has exited the location of the itinerary event; and
responsive to a determination that the customer has exited the itinerary event, automatically pay a vendor corresponding to the itinerary event on behalf of the customer.

21. The storage medium of claim 20, wherein the instructions further cause the processor to:
during an execution phase,
receive customer information while the customer is attending an event of the itinerary;
modify the customer profile based on the received customer information; and
utilize the modified customer profile in creating a future itinerary.
